(19) United States
(12) Patent Application Publication
(10) Pub. No.: US 2019/0325514 A1
(43) Pub. Date: Oct. 24, 2019

(54) CREDIT RISK PREDICTION METHOD AND DEVICE BASED ON LSTM MODEL

(71) Applicant: ALIBABA GROUP HOLDING LIMITED, GRAND CAYMAN (KY)

(72) Inventor: Manhuo HONG, HANGZHOU (CN)

(21) Appl. No.: 16/392,166

(22) Filed: Apr. 23, 2019

(30) Foreign Application Priority Data
Apr. 24, 2018 (CN) 201810373757.3

(51) Int. Cl. G06Q 40/02; G06N 20/00

(52) U.S. Cl. CPC G06Q 40/025; G06N 20/00

(57) ABSTRACT

Methods, systems and apparatus for credit risk prediction based on an Long Short-Term Memory (LSTM) model are provided. One of the methods includes obtaining behavior data of a target account in a period that includes a plurality of time intervals, and generating, based on the behavior data of the target account, a sequence of behavior vectors. Each behavior vector corresponds to one of the time intervals. The method further includes inputting the generated sequence of behavior vectors into an LSTM encoder in the LSTM model to obtain hidden state vectors each corresponding to one of the time intervals, and obtaining a risk score of the target account in a next time interval by inputting the hidden state vectors into an LSTM decoder of the LSTM model. The next time interval is next to the last time interval in the plurality of time intervals.

### CROSS-REFERENCE TO RELATED APPLICATIONS

The present application is based on and claims priority to the Chinese Patent Application No. 201810373757.3, filed on Apr. 24, 2018 and entitled “Credit Risk Prediction Method and Device Based on LSTM Model,” which is incorporated herein by reference in its entirety.

### TECHNICAL FIELD

The present application relates to the field of communications, and in particular, to a credit risk prediction method and device based on a Long Short-Term Memory (“LSTM”) model.

### BACKGROUND

Credit risk prediction models have been extensively used in existing credit risk prevention systems to prevent credit risks. A credit risk model is constructed by obtaining a large amount of risk-based transactions from risk-based accounts as training samples and extracting risk features from the training samples to train the credit risk model. Then, the constructed risk model is used for credit risk prediction and evaluation of a transaction account of a user.

### SUMMARY

The present specification provides a method for credit risk prediction based on an Long Short-Term Memory (LSTM) model. The method may include obtaining behavior data of a target account in a period that includes a plurality of time intervals, and generating a sequence of behavior vectors based on the behavior data of the target account. Each behavior vector corresponds to one of the time intervals. The method may further include inputting the generated sequence of behavior vectors into an LSTM encoder in an LSTM model to obtain hidden state vectors each corresponding to one of the time intervals. The LSTM model may include the LSTM encoder and an LSTM decoder. The method may further include obtaining a risk score of the target account in a next time interval by inputting the hidden state vectors into the LSTM decoder. The next time interval is next to the last time interval in the plurality of time intervals.

In some embodiments, the method may further include obtaining a weight of each hidden state vector on the risk score from the LSTM decoder. The weight of each hidden state vector indicates a contribution of the hidden state vector to the risk score.

In other embodiments, the method may further include obtaining behavior data of a plurality of sample accounts in the period comprising the plurality of time intervals; generating, based on the behavior data of the plurality of sample accounts, a sample sequence of behavior vectors. Each behavior vector in the sample sequence corresponds to one of the time intervals. The method further include training the LSTM model by using the generated sample sequence of behavior vectors as training samples.

In still other embodiments, obtaining behavior data of a plurality of sample accounts may include obtaining the behavior data based on a variety of user behaviors including one or more of credit performance behaviors, user consumption behaviors, and financial payment behaviors.

In yet other embodiments, generating, based on the behavior data of the plurality of sample accounts, a sample sequence of behavior vectors may include: extracting one or more factors from the obtained behavior data of the sample accounts; digitizing the one or more factors to obtain behavior vectors each corresponding to the behavior data in one of the time intervals; and splicing the behavior vectors to obtain the sample sequence of the behavior vectors.

In other embodiments, the factors may include statuses of debit or credit orders and debit or credit repayment amounts corresponding to the credit performance behaviors, categories and quantities of user consumption corresponding to the user consumption behaviors, and financial payment types and financial income amounts corresponding to the financing payment behaviors.

In still other embodiments, the LSTM encoder has a multi-layer many-to-one structure, and the LSTM decoder has a multi-layer many-to-many structure including equal numbers of input nodes and output nodes.

In yet other embodiments, inputting the generated sequence of behavior vectors into an LSTM encoder in an LSTM model to obtain hidden state vectors may include: inputting the generated sequence of behavior vectors into the LSTM encoder to obtain first hidden state vectors based on a forward propagation computation; and inputting a reverse of the generated sequence of the behavior vectors into the LSTM encoder to obtain second hidden state vectors based on a back propagation computation. Each first hidden state vector corresponds to one of the time intervals, and each second hidden state vector corresponds to one of the time intervals. Inputting the generated sequence of behavior vectors into an LSTM encoder in an LSTM model to obtain hidden state vectors may further include: for each time interval, splicing a first hidden state vector and a second hidden state vector both corresponding to the time interval to obtain the hidden state vector corresponding to the time interval.

In other embodiments, inputting the hidden state vectors into the LSTM decoder to obtain a risk score of the target account in a next time interval may include: inputting the hidden state vectors into the LSTM decoder to obtain an output vector of the target account in the next time interval; and digitizing the output vector to obtain the risk score of the target account in the next time interval.

In still other embodiments, the output vector is a multi-dimensional vector. Digitizing the output vector may include any one of the following: extracting a value of a sub-vector in the output vector as a risk score, where the value is between 0 and 1; in response to that the output vector comprises a plurality of sub-vectors whose values are between 0 and 1, calculating an average of the values of the plurality of sub-vectors as the risk score; and in response to that the output vector comprises a plurality of sub-vectors whose values are between 0 and 1, extracting the maximal value or the minimal value of the values of the plurality of sub-vectors as the risk score.

The present specification further provides a system for credit risk prediction based on an Long Short-Term Memory (LSTM) model. The system may include: one or more processors; and one or more computer-readable memories coupled to the one or more processors and having instructions stored thereon that are executable by the one or more processors to perform a method including: obtaining behavior data of a target account in a period, wherein the period comprises a plurality of time intervals; generating, based on the behavior data of the target account, a sequence of behavior vectors, each behavior vector corresponding to one of the time intervals; inputting the generated sequence of behavior vectors into an LSTM encoder in an LSTM model to obtain hidden state vectors each corresponding to one of the time intervals, wherein the LSTM model comprises the LSTM encoder and an LSTM decoder; and obtaining a risk score of the target account in a next time interval by inputting the hidden state vectors into the LSTM decoder, wherein the next time interval is next to the last time interval in the plurality of time intervals.

The present specification further provides a non-transitory computer-readable storage medium configured with instructions. The instructions are executable by one or more processors to cause the one or more processors to perform operations including: obtaining behavior data of a target account in a period, wherein the period comprises a plurality of time intervals; generating, based on the behavior data of the target account, a sequence of behavior vectors, each behavior vector corresponding to one of the time intervals; inputting the generated sequence of behavior vectors into an LSTM encoder in an LSTM model to obtain hidden state vectors each corresponding to one of the time intervals, wherein the LSTM model comprises the LSTM encoder and an LSTM decoder; and obtaining a risk score of the target account in a next time interval by inputting the hidden state vectors into the LSTM decoder, wherein the next time interval is next to the last time interval in the plurality of time intervals.

### BRIEF DESCRIPTION OF THE DRAWINGS

FIG. 1 is a flow chart of a credit risk prediction method based on an LSTM model according to some embodiments of the present specification;

FIG. 2 is a schematic diagram of an LSTM model based on an encoder-decoder architecture according to some embodiments of the present specification;

FIG. 3 is a schematic diagram of various types of multi-layer LSTM network architecture according to some embodiments of the present specification;

FIG. 4 is a schematic diagram of user group division according to some embodiments of the present specification;

FIG. 5 is a schematic diagram of constructing sequences of user behavior vectors for data nodes in an LSTM encoder according to some embodiments of the present specification;

FIG. 6 is a schematic hardware structure diagram of an electronic apparatus including a credit risk prediction device based on an LSTM model according to some embodiments of the present specification;

FIG. 7 is a logic block diagram of a credit risk prediction device based on an LSTM model according to some embodiments of the present specification.

### DETAILED DESCRIPTION

The present specification provides a technical solution for predicting a credit risk of a target account of a user, by using the user's operation behavior data of the target account (where the user's operation behavior data is also referred to as “behavior data” conveniently, hereinafter) in a period of time to train an encoder-decoder architecture based LSTM model and predicting the credit risk of the target account in a future period of time based on the trained LSTM model.

In some embodiments, a target period may be pre-set as a performance window during which a credit risk is to be predicted, another period may be pre-set as an observation window during which user behaviors of the target account are observed, and a time sequence is formed by using the performance window and observation window based on a time step. For example, the performance window, the observation window and the time step may be set by a modeling party.

For example, assuming that a credit risk of a target account of a user is to be predicted in the future six months based on the behavior data of the target account in the past 12 months, the performance window may be set as the future six months and the observation window may be set as the past 12 months. Assuming that a time step is set as one month, the performance window and the observation window may be divided into multiple time intervals based on the time step of one month to form a time sequence. Each time interval may be referred to as a data node in the formed time sequence.

Multiple sample accounts may be selected, e.g., accounts labeled with risk tags. Behavior data of these sample accounts in the observation window may be obtained. Based on the behavior data of these sample accounts in each time interval of the observation window, one or more sequences of user behavior vectors may be constructed corresponding to the time intervals. In some embodiments, each user behavior vector in each sequence corresponds to one time interval of the observation window. The one or more sequences of user behavior vectors may be further used as training samples to train the encoder-decoder architecture based LSTM model, where the LSTM model includes an LSTM encoder and an LSTM decoder having an attention mechanism. For convenience, a user behavior vector may be referred to as a behavior vector, and a sequence of user behavior vectors may be referred to as a user behavior vector sequence or a behavior vector sequence, hereinafter.

In some embodiments, these training samples may be inputted into the LSTM encoder for training the LSTM encoder. During the training of the LSTM encoder based on the training samples, hidden state vectors corresponding to the time intervals may be obtained and used as feature variables for training the LSTM decoder. The hidden state vectors may then be inputted into the LSTM decoder for training the LSTM decoder. The above process may be executed in an iterative manner until the training of the LSTM model is complete.

When the credit risk of the target account in the performance window is to be predicted based on the trained LSTM model, the same manner may be used to obtain behavior data of the target account in the observation window, and based on the behavior data of the target account in each time interval of the observation window, a sequence of user behavior vectors corresponding to the time intervals may be constructed as prediction samples. Then, these prediction samples may be inputted into the LSTM encoder of the LSTM model to obtain hidden state vectors corresponding to the time intervals.

Furthermore, the hidden state vectors obtained from computation by the LSTM encoder may be used as risk features of the target account to be inputted into the LSTM model. In some embodiments, a risk score of the target account as well as a weight of each hidden state vector corresponding to the risk score are outputted, where the weight of each hidden state vector represents the contribution made by the hidden state vector to the risk score.

In the above-described technical solution, the user behavior vector sequence of the target account corresponding to the time intervals are used as input data of the LSTM encoder in the LSTM model with an encoder-decoder architecture to obtain the hidden state vectors corresponding to the time intervals, and then the obtained hidden state vectors may be used as risk features and inputted into the LSTM decoder to complete the risk prediction of the target account to obtain the risk score. Therefore, feature variables may not need to be manually developed and explored for modeling based on the behavior data of the target account, thereby reducing the difficulties in in-depth mining of information from data due to inaccurate feature variables designed according to a human modeler's experience and avoiding the impact on the accuracy of risk prediction by the model built upon the inaccurate feature variables. Moreover, storage or maintenance of the manually designed feature variables may be avoided, thereby lowering the system's storage overhead.

In addition, an attention mechanism may be introduced into the LSTM decoder of the encoder-decoder architecture based LSTM model. For example, the hidden state vectors (also referred to as “hidden state variables”) corresponding to the time intervals obtained by the LSTM encoder may be used as risk features to input into the LSTM decoder for risk prediction computation and thus a weight of a hidden state vector corresponding to one time interval may be obtained. The weight of a hidden state vector indicates a contribution of the hidden state vector to the risk score. In some embodiments, the contribution made by each hidden feature variable to the risk score may be evaluated, and the interpretability of the LSTM model may be improved.

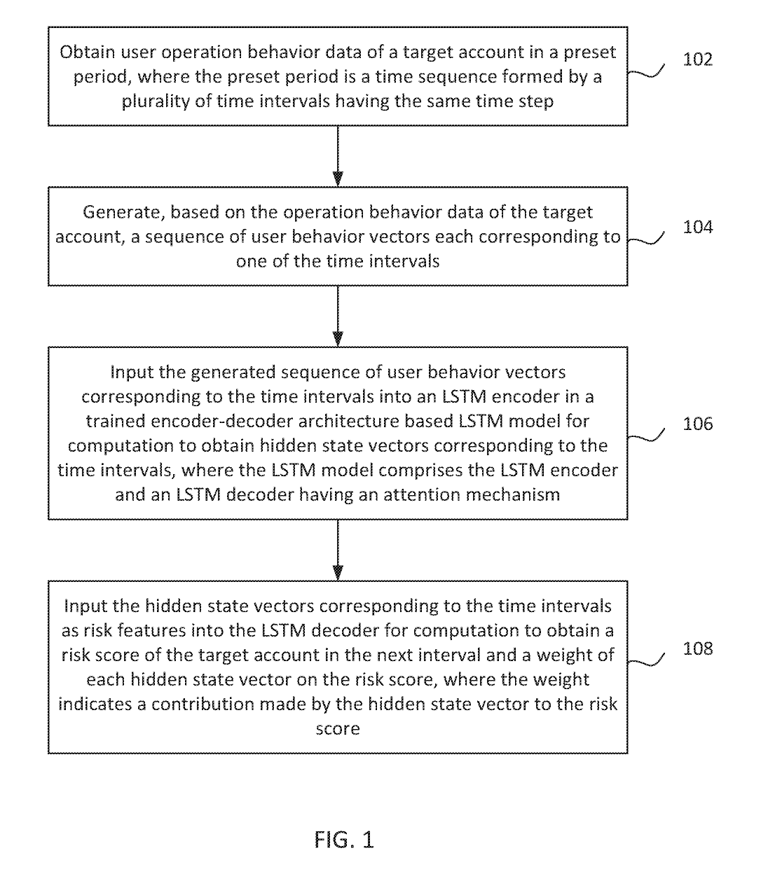

Referring to FIG. 1, a credit risk prediction method based on an LSTM model is provided according to some embodiments of the present specification. In some embodiments, the credit risk prediction method may be applicable on a server. The method may include the following steps:

Step 102, obtaining user operation behavior data of a target account in a preset period, where the preset period is a time sequence formed by multiple time intervals having the same time step;

Step 104, generating, based on the behavior data of the target account, a sequence of user behavior vectors each corresponding to one of the time intervals;

Step 106, inputting the generated sequence of user behavior vectors corresponding to the time intervals into an LSTM encoder in a trained encoder-decoder architecture based LSTM model for computation to obtain hidden state vectors corresponding to the time intervals, where the LSTM model includes the LSTM encoder and an LSTM decoder having an attention mechanism; and

Step 108, inputting the hidden state vectors corresponding to the time intervals as risk features into the LSTM decoder for computation to obtain a risk score of the target account in the next time interval and a weight of each hidden state vector on the risk score, where the weight indicates a contribution made by the hidden state vector to the risk score.

In some embodiments, a target account of a user may include the user's payment account, and the user may initiate a payment transaction by logging in the target account on a payment client (e.g., a payment Application (“APP”)). A server may be a standalone server, a server cluster or a cloud platform constructed based on server clusters. The server provides services to a user-oriented payment client and performs risk identification on the payment account used by the user to log in the client.

In some embodiments, the user operation behavior data may include data generated based on a variety of transaction-related operation behaviors of the user after the user logs in the target account on the client. For example, the operation behaviors may include the user's credit performance behaviors, user consumption behaviors, financial payment behaviors, store management behaviors, routine social behaviors, etc. When the user performs the above-listed operation behaviors via the client, the client may upload data generated based on the operation behaviors to the server, and the server stores the data in its local database as events.

As described above, a target time period may be pre-set as a performance window during which a credit risk is to be predicted and another time period may be pre-set as an observation window during which user behaviors of the target account are observed, and a time sequence may be formed by using the above-described performance window and observation window based on a time step. In some embodiments, the lengths of time periods corresponding to the performance window and the observation window may be customized by a modeling party according to a prediction goal. Correspondingly, the length of the time step may also be customized by the modeling party according to a business demand.

Assuming a credit risk of a target account in the future six months is to predicted based on user operation behavior data of the target account in the past 12 months and the time step is set as one month. In some embodiments, the performance window may be set as the past six months and the observation window may be set as the past 12 months. Further, according to the time step of one month, the performance window may be divided into six time intervals, all of which have a length of one month, and these time intervals are organized to form a time sequence, e.g., chronologically. Furthermore, the observation window may be divided into 12 time intervals, all of which have a length of one month, and these time intervals are organized to form a time sequence, e.g., chronologically.

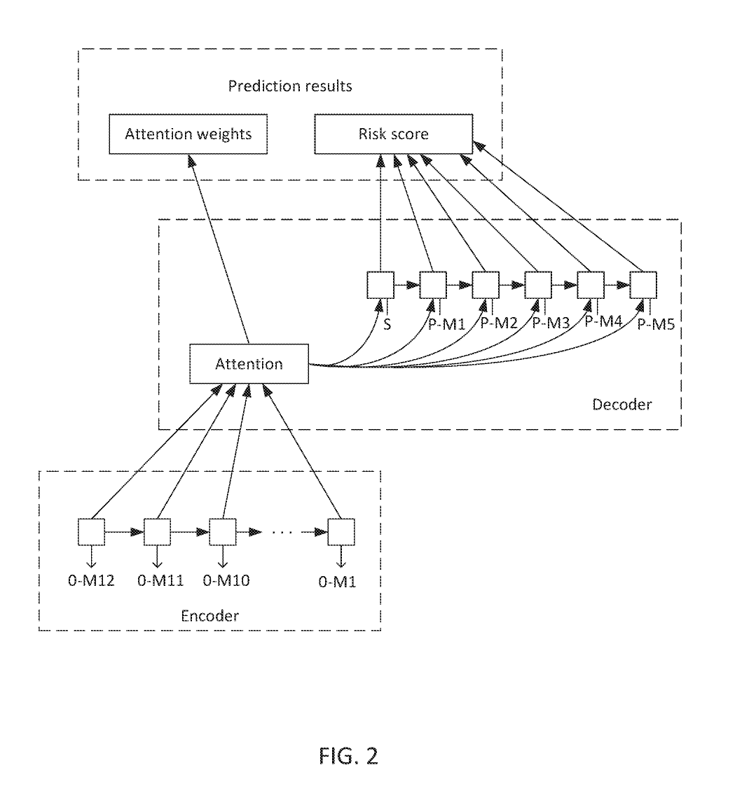

Referring to FIG. 2, an LSTM model based on an encoder-decoder architecture according to some embodiments of the present specification is provided. As shown in FIG. 2, the LSTM model based on the encoder-decoder architecture may include an LSTM encoder and an LSTM decoder in which an attention mechanism is introduced.

The LSTM encoder may include multiple data nodes which corresponds to the time intervals in the observation window. For example, each time interval in the observation window corresponds to a data node in the LSTM encoder. The LSTM encoder may be used to discover features in the sequence of user behavior vectors inputted by the data nodes in the observation window and to further input hidden state vectors (e.g., the discovered features such as risk features) outputted at the data nodes into the LSTM decoder.

The LSTM decoder may also include multiple data nodes corresponding to the time intervals in the performance window. For example, each time interval in the performance window corresponds to a data node in the LSTM decoder. The LSTM decoder may be used to predict credit risks at the data nodes in the performance window according to the risk features discovered by the LSTM encoder from the inputted sequence of user behavior vectors and the user's behaviors at the data nodes in the observation window, and to output a prediction result corresponding to each data node in the performance window.

In some embodiments, the time interval corresponding to the first data node in the LSTM decoder is next to the time interval corresponding to the last data node in the LSTM encoder. For example, in FIG. 2, a data node 0-M1 in the LSTM encoder corresponds to a time interval of the past month; a data node S in the LSTM decoder corresponds to a time interval of the current month; and a data node P-M1 in the LSTM decoder corresponds to a time interval of the next month.

In some embodiments, the attention mechanism is used to mark features (e.g., the risk features outputted by the data nodes of the LSTM encoder in the observation window) with weights corresponding to the prediction results outputted by the data nodes of the LSTM decoder in the performance window. For example, the weights represent the degrees of contribution (also referred to as “degrees of influence”) made by the features outputted by the data nodes of the LSTM encoder in the observation window on the prediction results outputted by the data nodes of the LSTM decoder in the performance window.

With the introduction of the attention mechanism, the contribution of the features detected by the data nodes of the LSTM encoder in the observation window to the prediction results outputted by the data nodes of the LSTM decoder in the performance window can be intuitively viewed, and the interpretability of the LSTM model is improved.

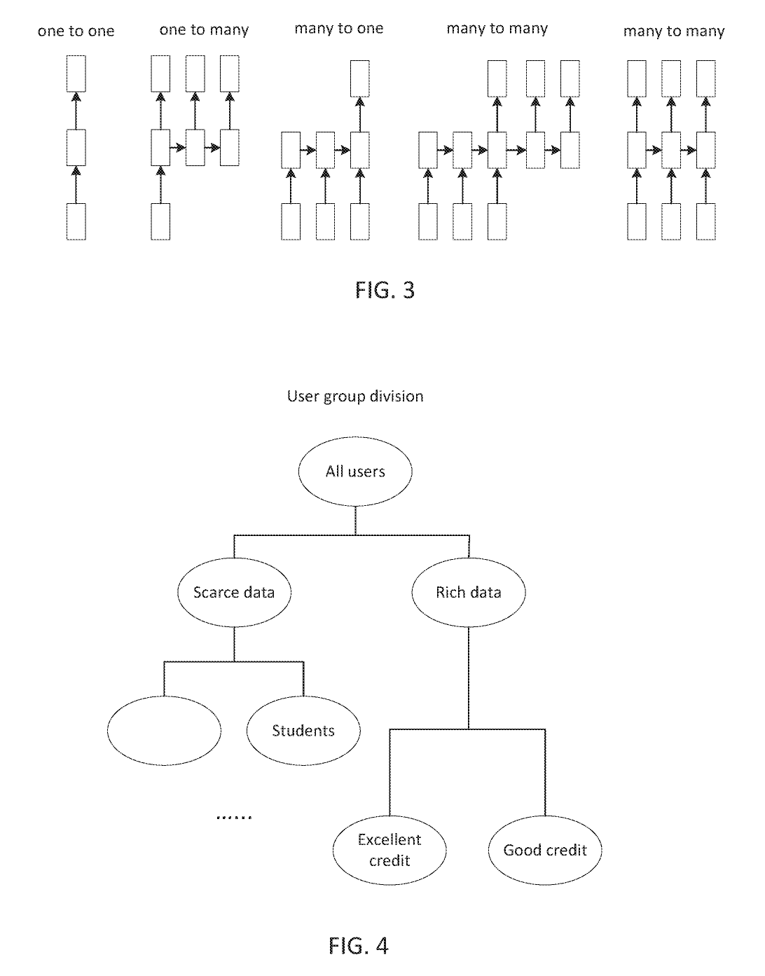

In some embodiments, the LSTM encoder and the LSTM decoder may both employ a multi-layer LSTM network architecture (e.g., greater than 3 layers), so as to portray operation behaviors of a user. For example, referring to FIG. 3, various types of the multi-layer LSTM network architecture are illustrated according to some embodiments. The multi-layer LSTM network architecture may have structural forms including, but not limited to, one-to-one, one-to-many, many-to-one, many-to-many in which the number of input nodes is different from that of output nodes, and many-to-many in which the number of input nodes is the same as that of output nodes.

In some embodiments, the LSTM encoder may combine the hidden state vectors outputted by the data nodes in the observation window into one input to the LSTM decoder Therefore, the LSTM encoder may employ the many-to-one structure shown in FIG. 3. The LSTM decoder may output a prediction result for each data node in the performance window respectively. Therefore, the LSTM decoder may employ the many-to-many structure which has the same number of input nodes and output nodes shown in FIG. 3.

Training and application of an encoder-decoder architecture based LSTM model, such as those described above, will be described in detail with reference to embodiments below.

### 1) User Group Division

Different user populations have relatively significant differences in the quantity of data, credit behavior performance, etc. Therefore, to avoid the impact of these differences on the accuracy of one model, users may be divided into groups according to the differences to build different LSTM models for assessment of credit risks for different groups of users. For each user group, an LSTM model may be trained to perform credit risk assessment on users in the user group.

In some embodiments, different features or manners may be used for dividing users into groups. For example, user group division may be performed according to features including, but not limited to, the quantity of data, the occupations of the users, the number of times of overdues, the users' ages, etc. As shown in FIG. 4, users may be divided into a group with scarce data and a group with rich data. Further, the group with scarce data may be divided into user groups according to the users' occupations, such as a wage earner group, a student group, etc. The group with rich data may be further divided according to the number of times of overdues into user groups of excellent credit, good credit, etc.

2) Training of an encoder-decoder architecture based LSTM

In some embodiments, when an LSTM model is to be trained for a user group (such as one of the user groups described above), a large amount of user accounts that belong to the users in the group may be collected as sample accounts. The user accounts may be labeled with risk tags. For example, a risk tag of an account may be a tag indicating whether a credit risk exists in the account. For example, a sample account having a credit risk may be labeled with a tag 1, while a sample account having no credit risk may be labeled with a tag 0. The percent of the sample accounts labeled with risk tags indicating a credit risk in the accounts and the percent of the sample accounts labeled with risk tags indicating no credit risk in the accounts may set according to modeling needs.

Further, user operation behavior data of these sample accounts labeled with risk tags generated in each time interval of the observation window may be obtained. Then, corresponding one or more sequences of user behavior vectors may be constructed based on the user operation behavior data for the data nodes in the observation window. Each data node corresponds to a time interval of the observation window. The constructed one or more sequences of user behavior vectors may be used as training samples to train the encoder-decoder architecture based LSTM model.

In some embodiments, a variety of user operation behaviors may be pre-defined for constructing one or more sequences of user behavior vectors. For example, a variety of user operation behavior data generated based on the variety of user operation behaviors of the sample accounts may be obtained in each time interval of the observation window. Key factors may be extracted from the obtained user operation behavior data. The extracted key factors may be digitized to obtain user behavior vectors, each of which corresponds to the user operation behavior data in one time interval corresponding to one data node in the observation window. Furthermore, after the user behavior vectors corresponding to the variety of user operation behavior data in the time intervals corresponding to the data nodes in the observation window are obtained, the user behavior vectors may be spliced to generate one or more sequences of the user behavior vectors.

In some embodiments, the variety of user operation behaviors may be determined according to actual needs. Different key factors may be extracted from the user operation behavior data. For example, important elements of the user operation behavior data may be used as the key factors.

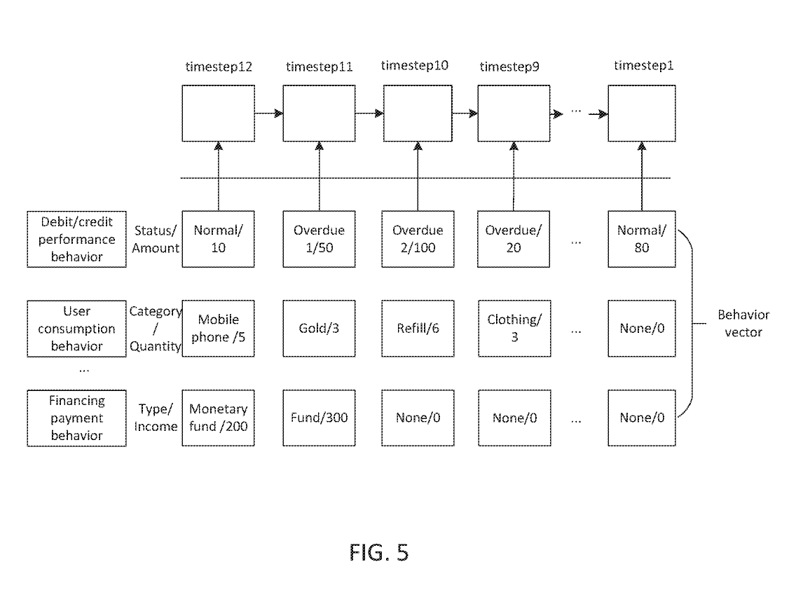

Referring to FIG. 5, a schematic diagram of constructing one or more sequences of user behavior vectors for the data nodes in the LSTM encoder is illustrated according to some embodiments of the present specification. In some embodiments, the variety of user operation behaviors may include, but are not limited to, credit performance behaviors, user consumption behaviors, and financial payment behaviors; and correspondingly, the key factors may include debit or credit order statuses and debit or credit repayment amounts corresponding to the credit performance behaviors, categories and quantities of user consumption corresponding to the user consumption behaviors, and financial payment types and financial income amounts corresponding to the financing payment behaviors.

For each time interval in the observation window, credit performance behavior data, user consumption behavior data, and financial payment behavior data of a sample account generated in the time interval may be obtained respectively. Then, a debit or credit order status (e.g., two statuses of normal and overdue, as shown in FIG. 5) and a debit or credit repayment amount (e.g., actual debit or credit amount and overdue amount, as shown in FIG. 5, such as “overdue 1/50” representing one time of overdue and an overdue amount of 50 Chinese Yuan, “normal/10” representing a normal repayment and a repayment amount of 10 Chinese Yuan) may be extracted from the credit performance behavior data, categories of user consumption (e.g., four categories of mobile phone, gold, refilling, and clothing, as shown in FIG. 5) and quantities of user consumption may be extracted from the user consumption behavior data, and financial payment types (e.g., two types of financial products, monetary fund and fund, as shown in FIG. 5) and financial income amounts may be extracted from the financing payment behavior data.

Further, in some embodiments, the information extracted from the credit performance behavior data, user consumption behavior data, and financial payment behavior data may be digitized to obtain a user behavior vector of each type of user operation behavior data corresponding to each time interval. Then, user behavior vectors of the above three types of user operation behavior data corresponding to each time interval may be spliced to obtain one or more sequences of the user behavior vectors corresponding to each time interval. In other embodiments, the information extracted from the credit performance behavior data, user consumption behavior data, and financial payment behavior data may be digitized to obtain a user behavior vector of the three types of user operation behavior data corresponding to each time interval. The user behavior vectors corresponding to multiple time intervals in the observation window may be spliced to obtain a sequence of the user behavior vectors corresponding to the multiple time intervals in the observation window. For example, a sequence of user behavior vectors may be represented as X=(X₁, X₂, . . . , X_{T}), where X₁, X₂, . . . , X_{T} each represents a user behavior vector corresponding to multiple types of user operation behavior data in one time interval, 1, 2, . . . , T, respectively.

In some embodiments, computation by the LSTM encoder in LSTM model may include input gate computation, memory gate (also referred to as “forget gate”) computation, unit state computation, and hidden state vector computation. The hidden state vectors obtained from computation by the LSTM encoder may be combined into an input to the LSTM decoder. The equations involved in the above-described computations are shown below:

f(t)=f(W_{f}*Xᵢ+U_{f}*h(t−1)+b_{f})

i(t)=f(Wᵢ*Xᵢ+Uᵢ*h(t−1)+bᵢ)

m(t)=tan h(Wₘ*Xᵢ+Uₘ*h(t−1)+bₘ)

h(t)=f(t)*h(t−1)+i(t)*m(t)

where, f(t) represents a memory gate of the t^{th} data node of the LSTM encoder; i(t) represents an input gate of the t^{th} data node of the LSTM encoder; m(t) represents a unit state (also referred to as “a candidate hidden state”) of the t^{th} data node of the LSTM encoder; h(t) represents a hidden state vector corresponding to the t^{th} data node (i.e., the t^{th} time interval) of the LSTM encoder; h(t−1) represents a hidden state vector corresponding to the data node before the t^{th} data node of the LSTM encoder; f represents a nonlinear activation function, which may be selected according to actual needs (for example, for the LSTM encoder, f may be a sigmoid function); W_{f} and U_{f} represent weight matrices of the memory gate; b_{f} represents offset of the memory gate; Wᵢ and Uᵢ each represents a weight matrix of the input gate; bᵢ represents an offset of the input gate; Wₘ and Uₘ each represents a weight matrix of the unit state; and bₘ represents an offset of the unit state.

In some embodiments, computation involved in the attention mechanism of the LSTM decoder in the LSTM model may include computation of values of the contributions and computation of normalizing the values of the contributions to convert the values of the contributions to weights. For example, the values of contribution are normalized into a range of 0 to 1. The equations involved in the above-described computation are shown below:

e(t)(j)=tan h(Wₐ*s(j−1)+Uₐ*h(t))

a(t)(j)=exp(e(t)(j))/sum_T(exp(e(t)(j)))

where, e(t)(j) represents the value of contribution made by a hidden state vector corresponding to the t^{th} data node of the LSTM encoder to a prediction result corresponding to the j^{th} data node of the LSTM decoder; a(t)(j) represents a weight obtained after normalization of e(t)(j); exp(e(t)(j)) represents performing an exponential function operation on e(t)(j); sum_T(exp(e(t)(j))) represents summing e(t)(j) of a total of T data nodes of the LSTM encoder; s(j−1) represents a hidden state vector corresponding to the (j−1)^{th} data node of the LSTM decoder; and Wₐ and Uₐ each represents a weight matrix of the attention mechanism.

In the above-described equation, a result of the exponential function operation on the value of e(t)(j) is divided by a result of summing e(t)(j) of a total of T data nodes of the LSTM encoder to normalize the value of e(t)(j) to an interval [0,1]. In some embodiments, in addition to the normalization manner shown in the above-described equation, those skilled in the art may also use other normalization manners.

In some embodiments, computation by the LSTM decoder in the LSTM model may include input gate computation, memory gate computation, output gate computation, unit state computation, hidden state vector computation, and output vector computation. The equations involved in the above-described computation are shown below:

F(j)=f(W_{F}*Cⱼ+U_{F}*S(j−1)+K_{F}*y(j−1)+b_{F})

I(j)=f(W_{I}*Cⱼ+U_{I}*S(j−1)+K_{I}*y(j−1)+b₁)

O(j)=f(Wₒ*Cⱼ+U_{O}*S(j−1)+K_{O}*y(j−1)+b_{O})

n(j)=tan h(Wₙ*Cⱼ+Uₙ*S(j−1)+Kₘ*y(j−1)+bₙ)

S(j)=F(j)*S(j−1)+I(j)*n(j)

y(j)=0(j)*tan h(S(j))

Cⱼ=sum_T(a(t)(j)*h(t))

where, F(j) represents a memory gate of the j^{th} data node of the LSTM decoder; I(j) represents an input gate of the j^{th} data node of the LSTM decoder; O(j) represents an output gate of the j^{th} data node of the LSTM decoder; n(j) represents a unit state of the j^{th} data node of the LSTM decoder; S(j) represents a hidden state vector corresponding to the j^{th} data node of the LSTM decoder; S(j−1) represents a hidden state vector corresponding to the data node before the j^{th} data node (i.e., (j−1)^{th} data node) of the LSTM decoder; y(j) represents an output vector corresponding to the j^{th} data node of the LSTM decoder; f represents a nonlinear activation function, which may be selected according to actual needs (for example, for the LSTM decoder, f may also use a sigmoid function); Cⱼ represents a weighted sum obtained by multiplying the hidden state vectors h(t) corresponding to the data nodes of the LSTM encoder by the attention weights a(t)(j) that are obtained according to the attention mechanism of the LSTM decoder; W_{F}, U_{F}, and K_{F} each represent a weight matrix of the memory gate; b_{F} represents an offset of the memory gate; W_{I}, U_{I}, and K_{I} each represents a weight matrix of the input gate; b_{I} represents an offset of the input gate; W₀, U₀, and K₀ each represents a weight matrix of the output gate; b₀ represents an offset of the output gate; Wₙ, Uₙ, and Kₙ each represent a weight matrix of the unit state; bₙ represents an offset of the unit state.

The parameters listed in the above-described equations, i.e., W_{f}, U_{f}, b_{f}, Wᵢ, Uᵢ, bᵢ, Wₘ, Uₘ, bₘ, Wₐ, Uₐ, W_{F}, U_{F}, K_{F}, b_{F}, Wᵢ, U₁, K_{b} b₁, W₀, U₀, K₀, b₀, Wₙ, Uₙ, Kₙ, and bₙ, may be the parameters of the LSTM model after training. When the LSTM model is being trained, the one or more sequences of user behavior vectors corresponding to the time intervals constructed according to the user operation behavior data of the sample accounts labeled with risk tags may be used as training samples and inputted into the LSTM encoder for training. The computation results of the LSTM encoder may be inputted into the LSTM decoder for training. The model parameters may be repeatedly adjusted through an iteration of the above training process until the model parameters are optimized and the model training algorithm converges, thereby completing the training of the LSTM model. In some embodiments, a gradient descent method may be used for repeated iterative operation to train the LSTM model.

### 3) Credit Risk Prediction by the Encoder-Decoder Architecture Based LSTM Model

In some embodiments, one LSTM model is trained for each of the user groups according to the model training process illustrated in the above embodiments, and a credit risk assessment is performed on user accounts of the user group based on the trained LSTM model. For example, user operation behavior data of a target account generated in each time interval of the observation window may be obtained, and a corresponding sequence of user behavior vectors may be constructed for each data node in the observation window according to the obtained user operation behavior data of the target account. Each time interval may corresponds to each data node in the observation window. The process of constructing the sequence of user behavior vectors for the target account may still be achieved through the manner shown in FIG. 5, as described in the above embodiments.

After the sequence of the user behavior vectors corresponding to the time intervals in the observation window are constructed for the target account, an LSTM model corresponding to the user group to which the target account belongs may first be determined from the trained LSTM models. Then, the sequence of the user behavior vectors may be used as prediction samples and inputted into the data nodes in the LSTM encoder of the LSTM model for computation.

In some embodiments, one of forward propagation computation and back propagation computation may be used in the LSTM model. The forward propagation computation means that the order of inputting the user behavior vectors in the sequence corresponding to the time intervals in the observation window into the LSTM model is the same as the propagation direction of the data nodes in the LSTM model. For example, the sequence of the user behavior vectors may be in an order according to the propagation direction of the data nodes in the LSTM model. In contrast, the back propagation computation means that the order of inputting the user behavior vectors in the sequence corresponding to the time intervals in the observation window into the LSTM model is a reverse of the propagation direction of the data nodes in the LSTM model. Namely, the sequence of the user behavior vectors as input data to the back propagation computation is a reverse of that to the forward propagation computation.

For example, take forward propagation computation as an example, a user behavior vector X₁ of the target account corresponding to the 1^{st} time interval (i.e., the 1^{st} month) in the observation window may be used as data input for the 1^{st} data node in the propagation direction of the data nodes in the LSTM encoder. According to the above-listed LSTM encoding equations, f(1), i(1), and m(1) are obtained, and then the hidden state vector h(1) corresponding to the 1^{st} time interval is obtained based on the obtained f(1), i(1), and m(1). Then, a user behavior vector X₂ corresponding to the 2^{nd} time interval is used as data input for the 2^{nd} data node in the propagation direction of the data nodes in the LSTM encoder, and computation is performed using the same computation method. The process is repeated to sequentially obtain hidden state vectors h(2) to h(12) corresponding to the 2^{nd} to 12^{th} time intervals respectively.

In another example, take back propagation computation as an example, the user behavior vector Xie of the target account corresponding to the 12^{th} time interval (i.e., the last time interval) in the observation window may be used as data input for the 1^{st} data node in the propagation direction of the data nodes in the LSTM encoder. The same computation method is used to obtain f(1), i(1), and m(1), and then the hidden state vector h(1) corresponding to the 1^{st} time interval is obtained based on the obtained f(1), i(1), and m(1). Then, the user behavior vector X₁₁ corresponding to the 11^{th} time interval is used as data input for the 2^{nd} data node in the propagation direction of the data nodes in the LSTM encoder, and computation is performed using the same computation method. The process is repeated to sequentially obtain hidden state vectors h(2) to h(12) corresponding to the 2nd to 12^{th} time intervals respectively.

In some embodiments, to improve the computation accuracy of the LSTM encoder, bi-directional propagation computation is used for the computation in the LSTM encoder. When the forward propagation computation and the back propagation computation are completed, a first hidden state vector obtained from the forward propagation computation and a second hidden state vector obtained from the back propagation computation may be obtained for each data node in the LSTM encoder.

Further, the first hidden state vector and the second hidden state vector corresponding to the each data node in the LSTM encoder may be spliced and used as the final hidden state vector corresponding to the each data node. Take the t^{th} data node of the LSTM encoder as an example, assuming that for this data node, the obtained first hidden state vector is recorded as ht_before, the obtained second hidden state vector is recorded as ht_after, and the final hidden state vector is recorded as ht_final, ht_final may be expressed as t_final=[ht_before, ht_after].

In some embodiments, one or more sequences of user behavior vectors corresponding to the time intervals in the observation window are constructed for the target account and used as prediction samples to input into the data nodes in the LSTM encoder of the LSTM model. When the computation is completed, hidden state vectors obtained from the computation at the data nodes in the LSTM encoder may be used as risk features and further inputted into the LSTM decoder of the LSTM model. The risk features may be deemed as features extracted from the user operation behavior data of the target account. Then, computation is performed according to the equations of the LSTM decoder shown in the above embodiments, so as to predict credit risks of the target account in the time intervals of the performance window.

For example, attention weights a(t)(j) of the hidden state vectors corresponding to the data nodes in the LSTM encoder may first be calculated according to the attention mechanism of the LSTM decoder, and the weighted sum Cⱼ is further calculated by multiplying the hidden state vectors corresponding to the data nodes in the LSTM encoder by corresponding attention weights a(t)(j). Then, an output vector corresponding to the first data node in the LSTM decoder is further calculated based on the above-listed equations of the LSTM decoder to predict credit risk of the target account in the first time interval of the performance window. The process is repeated, and thus, an output vector corresponding to the next data node in the LSTM decoder is sequentially calculated based on the above-listed equations of the LSTM decoder in the same manner to predict credit risk of the target account in the next time interval of the performance window. In some embodiments, the process may be repeated until the computation of the LSTM decoder is completed, and therefore attention weights a(t)(j) of the hidden state vectors corresponding to the data nodes in the LSTM encoder and output vectors corresponding to the data nodes in the LSTM decoder may be obtained.

In some embodiments, the LSTM model may further digitize the output vectors corresponding to the data nodes in the LSTM decoder, and convert the output vectors corresponding to the data nodes to risk scores corresponding to the data nodes as results of credit risk prediction for the target account in the time intervals of the performance window. Different manners in which the output vectors are digitized and converted to risk scores may be used in the embodiments of the present specification. For example, the finally outputted output vector may be a multi-dimensional vector, and the output vector may include a sub-vector whose value is between 0 and 1. For example, the sub-vector includes one element whose values is between 0 and 1. Therefore, the value of the sub-vector, which is between 0 and 1, may be extracted from the output vector as a risk score corresponding to the output vector.

In another example, if the output vector includes multiple sub-vectors whose values are between 0 and 1, the maximal value or the minimal value of the values of the multiple sub-vectors may be extracted as the risk score corresponding to the output vector; alternatively, an average of the values of the multiple sub-vectors may be calculated as the risk score.

When the above-described computation is completed, the LSTM decoder may output the risk scores corresponding to the data nodes in the LSTM decoder, as well as the weights of the hidden state vectors obtained for the data nodes in the LSTM encoder as the final prediction result. The weights of the hidden state vectors indicate the contributions of the hidden state vectors to the risk scores respectively.

In some embodiments, the LSTM decoder may also combine the risk scores corresponding to the data nodes in the LSTM decoding, and then convert the combined risk scores to a prediction result indicating whether the target account has a credit risk in the performance window. For example, the LSTM decoder may sum the risk scores corresponding to the data nodes in the LSTM decoding and then compare the sum of the risk scores with a preset risk threshold; if the sum of the risk scores is greater than the risk threshold, the LSTM decoder outputs 1, indicating that the target account has a credit risk in the performance window; on the contrary, if the sum of the risk scores is smaller than the risk threshold, the LSTM decoder outputs 0, indicating that the target account does not have a credit risk in the performance window.

According to the above embodiments, a sequence of user behavior vectors of the target account in the time intervals are used as input data for the LSTM encoder in the encoder-decoder architecture based LSTM model for computation to obtain the hidden state vectors corresponding to the time intervals. The obtained hidden state vectors may be used as risk features to input into the LSTM decoder for computation to complete the risk prediction of the target account to obtain the risk score.

In addition, an attention mechanism may be introduced into the LSTM decoder of the encoder-decoder architecture based LSTM model. For example, the hidden state vectors (also referred to as “hidden state variables”) corresponding to the time intervals obtained by the LSTM encoder may be used as risk features to input into the LSTM decoder for risk prediction computation and thus a weight of a hidden state vector corresponding to one time interval may be obtained. The weight of a hidden state vector indicates a contribution of the hidden state vector to the risk score. In some embodiments, the contribution made by each hidden feature variable to the risk score may be evaluated, and the interpretability of the LSTM model may be improved.

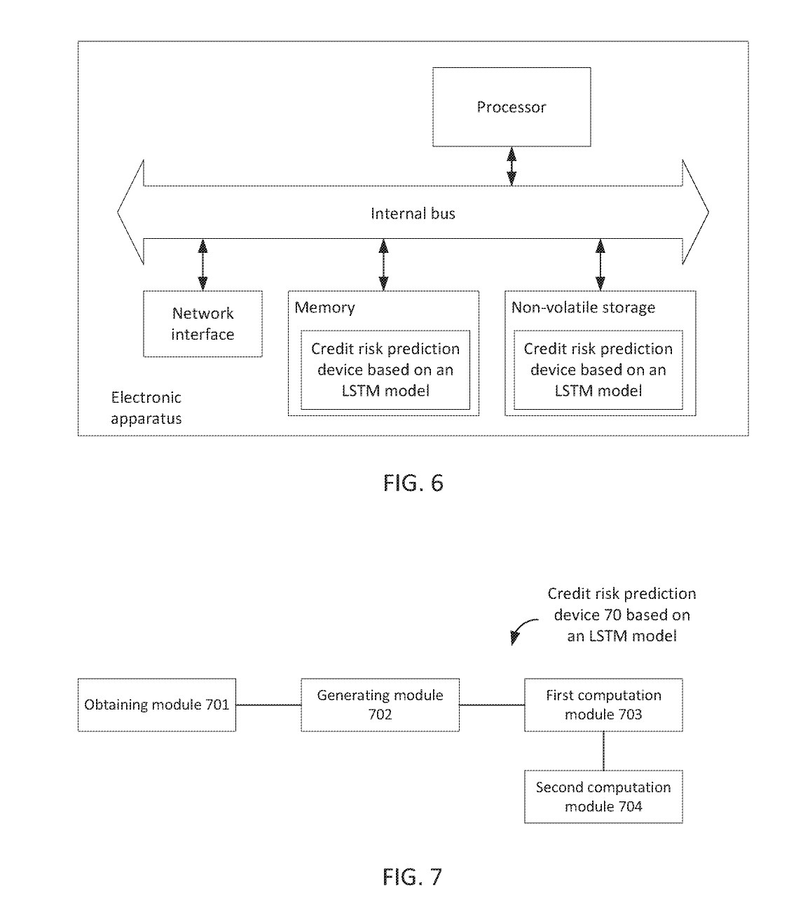

Corresponding to the above method embodiments, the present specification further provides a credit risk prediction device based on an LSTM model. Embodiments of the credit risk prediction device based on an LSTM model may be applicable on electronic apparatuses. The device embodiments may be implemented by software, hardware, or a combination of software and hardware. Taking software implementation as an example, a device in the sense of logics is formed by a processor of the electronic apparatus where the device is located reading corresponding computer program instructions in a non-volatile storage into a memory. From the hardware layer, FIG. 6 is a schematic hardware structure diagram of an electronic apparatus including a credit risk prediction device based on an LSTM model according to some embodiments of the present specification. For example, the electronic apparatus is a server. In addition to the processor, memory, network interface, and non-volatile storage shown in FIG. 6, the electronic apparatus including the device in the embodiments may further include other hardware according to actual functions of the electronic apparatus.

FIG. 7 is a block diagram of a credit risk prediction device based on an LSTM model according to some embodiments of the present specification. Referring to FIG. 7, the credit risk prediction device 70 based on an LSTM model is applicable on the electronic apparatus shown in FIG. 6. As shown in FIG. 7, the device may include: an obtaining module 701, a generating module 702, a first computation module 703, and a second computation module 704.

The obtaining module 701 is configured to obtain user operation behavior data of a target account in a preset period, where the preset period is a time sequence formed by multiple time intervals having the same time step.

The generating module 702 is configured to generate, based on the operation behavior data of the target account, a sequence of user behavior vectors each corresponding to one of the time intervals.

The first computation module 703 is configured to input the generated sequence of user behavior vectors corresponding to the time intervals into an LSTM encoder in a trained encoder-decoder architecture based LSTM model for computation to obtain hidden state vectors corresponding to the time intervals, where the LSTM model includes the LSTM encoder and an LSTM decoder having an attention mechanism.

The second computation module 704 is configured to input the hidden state vectors corresponding to the time intervals as risk features into the LSTM decoder for computation to obtain a risk score of the target account in the next interval and a weight of each hidden state vector on the risk score, where the weight indicates the contribution made by the hidden state vector to the risk score.

In some embodiments, the obtaining module 701 is further configured to: obtain user operation behavior data of multiple sample accounts labeled with risk tags in the preset period. The generating module 702 is further configured to: generate, based on the user operation behavior data of the multiple sample accounts in the time intervals, one or more sequences of user behavior vectors corresponding to the time intervals. The device 70 may further include: a training module (not shown in FIG. 7) configured to use the generated one or more sequences of the user behavior vectors as training samples to train an encoder-decoder architecture based LSTM model.

In some embodiments, the generating module 702 is further configured to: obtain a variety of user operation behavior data of the accounts (e.g., sample accounts) in each time interval; extract key factors from the obtained user operation behavior data, and digitize the key factors to obtain user behavior vectors corresponding to the user operation behavior data; and splice the user behavior vectors corresponding to the variety of user operation behavior data in the time intervals to generate one or more sequences user behavior vectors corresponding to the time intervals.

In some embodiments, the variety of user behaviors include credit performance behaviors, user consumption behaviors, and financial payment behaviors; and the key factors include debit or credit order statuses and debit or credit repayment amounts corresponding to the credit performance behaviors, categories and quantities of user consumption corresponding to the user consumption behaviors, and financial payment types and financial income amounts corresponding to the financing payment behaviors.

In some embodiments, the LSTM encoder uses a multi-layer many-to-one structure, and the LSTM decoder uses a multi-layer many-to-many structure which includes the same number of input nodes and output nodes.

In some embodiments, the first computation module 703 is configured to: input the generated user behavior vectors in the sequence corresponding to the time intervals into the LSTM encoder in the trained LSTM model that is based on the encoder-decoder architecture for bidirectional propagation computation to obtain a first hidden state vector according to forward propagation computation, and a second hidden state vector according to back propagation computation, where the order of inputting the user behavior vectors in the sequence corresponding to the time intervals for the forward propagation computation is reversed when inputting the user behavior vectors in the sequence corresponding to the time intervals for the back propagation computation; and splice the first hidden state vector and the second hidden state vector to obtain a final hidden state vector corresponding to each time interval.

In some embodiments, the second computation module 704 is configured to: input the hidden state vectors corresponding to the time intervals as risk features into the LSTM decoder for computation to obtain an output vector of the target account in the next time interval; and digitize the output vector to obtain a risk score of the target account in the next time interval.

In some embodiments, the output vector is a multi-dimensional vector; and the digitizing the output vector includes any one of the following: extracting a value of a sub-vector, which is between 0 and 1, from the output vector as a risk score; if the output vector includes two or more sub-vectors whose values are between 0 and 1, calculating an average of the values of the two or more sub-vectors as the risk score; and if the output vector includes two or more sub-vectors whose values are between 0 and 1, extracting the maximal value or the minimal value of the values of the two or more sub-vectors as the risk score.

The process of corresponding steps in the above-described method embodiments may be referenced for details of the process of functions and roles of the modules in the above-described device. In the above-described device embodiments, the modules described as separate parts may or may not be physically separated, and the parts illustrated as modules may or may not be physical modules, i.e., they may be located at one place or distributed over a plurality of network modules. The objectives of the solutions of the present specification can be achieved by selecting some or all of the modules as needed, which can be understood and implemented by one of ordinary skill in the art without creative effort.

The system, device, module, or module elaborated in the embodiments may be achieved by a computer chip or entity or by a product having a function. One example of the apparatus is a computer, and an example of the form of the computer may be a personal computer, a laptop computer, a cellular telephone, a camera phone, a smart phone, a personal digital assistant, a media player, a navigation device, an email receiving and transmitting device, a game console, a tablet computer, a wearable device, or a combination of several of the above apparatuses.

Corresponding to the above method embodiments, the present specification further provides some embodiments of an electronic apparatus. The electronic apparatus includes: a processor and a memory for storing machine-executable instructions, where the processor and the memory may be connected with each other via an internal bus. In other embodiments, the apparatus may further includes an external interface for communications with other apparatuses or parts.

In some embodiments, by reading and executing the machine-executable instructions stored in the memory and corresponding to a control logic of credit risk prediction based on an LSTM model, the processor is caused to: obtain user operation behavior data of a target account in a preset period, where the preset period is a time sequence formed by multiple time intervals having the same time step; generate, based on the operation behavior data of the target account, a sequence of user behavior vectors each corresponding to one of the time intervals; input the generated sequence of user behavior vectors corresponding to the time intervals into an LSTM encoder in a trained encoder-decoder architecture based LSTM model for computation to obtain hidden state vectors corresponding to the time intervals, where the LSTM model includes the LSTM encoder and an LSTM decoder having an attention mechanism; and input the hidden state vectors corresponding to the time intervals as risk features into the LSTM decoder for computation to obtain a risk score of the target account in the next time interval and a weight of each hidden state vector on the risk score, where the weight indicates the contribution made by the hidden state vector to the risk score.

In some embodiments, by reading and executing the machine-executable instructions stored in the memory and corresponding to a control logic of credit risk prediction based on an LSTM model, the processor is further caused to: obtain user operation behavior data of multiple sample accounts labeled with risk tags in the preset period; generate, based on the user operation behavior data of the multiple sample accounts in the time intervals, one or more sequences of user behavior vectors corresponding to the time intervals; and use the one or more generated sequences of user behavior vectors as training samples to train an encoder-decoder architecture based LSTM model.

In some embodiments, by reading and executing the machine-executable instructions stored in the memory and corresponding to a control logic of credit risk prediction based on an LSTM model, the processor is further caused to: obtain a variety of user operation behavior data of the sample accounts in each time interval; extract key factors from the obtained user operation behavior data, and digitize the key factors to obtain user behavior vectors corresponding to the user operation behavior data; and splice the user behavior vectors corresponding to the variety of user operation behavior data in the time intervals to generate a sequence user behavior vectors corresponding to the time intervals.

In some embodiments, by reading and executing the machine-executable instructions stored in the memory and corresponding to a control logic of credit risk prediction based on an LSTM model, the processor is further caused to: input the generated user behavior vectors in the sequence corresponding to the time intervals into the LSTM encoder in the trained LSTM model that is based on the encoder-decoder architecture for bidirectional propagation computation to obtain a first hidden state vector according to forward propagation computation, and a second hidden state vector according to back propagation computation, where the order of inputting the user behavior vectors in the sequence corresponding to the time intervals for the forward propagation computation is reversed when inputting the user behavior vectors in the sequence corresponding to the time intervals for the back propagation computation; and splice the first hidden state vector and the second hidden state vector to obtain a final hidden state vector corresponding to each time interval.

In some embodiments, by reading and executing the machine-executable instructions stored in the memory and corresponding to a control logic of credit risk prediction based on an LSTM model, the processor is further caused to: input the hidden state vectors corresponding to the time intervals as risk features into the LSTM decoder for computation to obtain an output vector of the target account in the next time interval; and digitize the output vector to obtain a risk score of the target account in the next time interval.

In some embodiments, the output vector is a multi-dimensional vector; and by reading and executing the machine-executable instructions stored in the memory and corresponding to a control logic of credit risk prediction based on an LSTM model, the processor is further caused to execute any one of the following: extracting a value of a sub-vector, which is between 0 and 1, from the output vector as a risk score; if the output vector includes two or more sub-vectors whose values are between 0 and 1, calculating an average of the values of the two or more sub-vectors as the risk score; if the output vector includes two or more sub-vectors whose values are between 0 and 1, extracting the maximal value or the minimal value of the values of the two or more sub-vectors as the risk score.

It will be easy for one of ordinary skill in the art to conceive of other implementation manners of the present specification after considering the specification and practicing the invention disclosed in the present specification. The present specification is intended to encompass any variations, uses or adaptive modifications of the present specification. All these variations, uses or adaptive modifications follow the general principles of the present specification and include common general knowledge or common technical means in the art that are not disclosed by the present specification. The specification and embodiments are merely exemplary, and the true scope and spirit of the present specification are subject to the appended claims.

It should be understood that the present specification is not limited to the accurate structures described above and illustrated in the accompanying drawings, and the present specification may be modified or amended in various manners without departing from the scope of the present specification. The scope of the present specification shall only be subject to the appended claims.

The above-described is only some embodiments of the present specification that are not used to limit the present specification. Any modification, equivalent substitution, and improvement made within the spirit and principle of the present specification shall fall within the protection scope of the present specification.

What is claimed is:

1. A computer-implemented method for credit risk prediction based on an Long Short-Term Memory (LSTM) model, the method comprising:
obtaining behavior data of a target account in a period, wherein the period comprises a plurality of time intervals;
generating, based on the behavior data of the target account, a sequence of behavior vectors, each behavior vector corresponding to one of the time intervals;
inputting the generated sequence of behavior vectors into an LSTM encoder in an LSTM model to obtain hidden state vectors each corresponding to one of the time intervals, wherein the LSTM model comprises the LSTM encoder and an LSTM decoder; and
obtaining a risk score of the target account in a next time interval by inputting the hidden state vectors into the LSTM decoder, wherein the next time interval is next to the last time interval in the plurality of time intervals.

2. The method according to claim 1, further comprising: obtaining a weight of each hidden state vector on the risk score from the LSTM decoder, wherein the weight of each hidden state vector indicates a contribution of the hidden state vector to the risk score.

3. The method according to claim 1, further comprising:
obtaining behavior data of a plurality of sample accounts in the period comprising the plurality of time intervals;
generating, based on the behavior data of the plurality of sample accounts, a sample sequence of behavior vectors, each behavior vector in the sample sequence corresponding to one of the time intervals; and
training the LSTM model by using the generated sample sequence of behavior vectors as training samples.

4. The method according to claim 3, wherein obtaining behavior data of a plurality of sample accounts comprises: obtaining the behavior data based on a variety of user behaviors including one or more of credit performance behaviors, user consumption behaviors, and financial payment behaviors.

5. The method according to claim 3, wherein generating, based on the behavior data of the plurality of sample accounts, a sample sequence of behavior vectors comprises:
extracting one or more factors from the obtained behavior data of the sample accounts;
digitizing the one or more factors to obtain behavior vectors each corresponding to the behavior data in one of the time intervals; and
splicing the behavior vectors to obtain the sample sequence of the behavior vectors.

6. The method according to claim 5, wherein the factors comprise statuses of debit or credit orders and debit or credit repayment amounts corresponding to the credit performance behaviors, categories and quantities of user consumption corresponding to the user consumption behaviors, and financial payment types and financial income amounts corresponding to the financing payment behaviors.

7. The method according to claim 1, wherein the LSTM encoder has a multi-layer many-to-one structure, and the LSTM decoder has a multi-layer many-to-many structure including equal numbers of input nodes and output nodes.

8. The method according to claim 1, wherein inputting the generated sequence of behavior vectors into an LSTM encoder in an LSTM model to obtain hidden state vectors comprises:
inputting the generated sequence of behavior vectors into the LSTM encoder to obtain first hidden state vectors based on a forward propagation computation, each first hidden state vector corresponding to one of the time intervals;
inputting a reverse of the generated sequence of the behavior vectors into the LSTM encoder to obtain second hidden state vectors based on a back propagation computation, each second hidden state vector corresponding to one of the time intervals; and
for each time interval, splicing a first hidden state vector and a second hidden state vector both corresponding to the time interval to obtain the hidden state vector corresponding to the time interval.

9. The method according to claim 1, wherein inputting the hidden state vectors into the LSTM decoder to obtain a risk score of the target account in a next time interval comprises:
inputting the hidden state vectors into the LSTM decoder to obtain an output vector of the target account in the next time interval; and
digitizing the output vector to obtain the risk score of the target account in the next time interval.

10. The method according to claim 9, wherein the output vector is a multi-dimensional vector; and
digitizing the output vector comprises any one of the following:
extracting a value of a sub-vector in the output vector as a risk score, wherein the value is between 0 and 1;
in response to that the output vector comprises a plurality of sub-vectors whose values are between 0 and 1, calculating an average of the values of the plurality of sub-vectors as the risk score; and
in response to that the output vector comprises a plurality of sub-vectors whose values are between 0 and 1, extracting the maximal value or the minimal value of the values of the plurality of sub-vectors as the risk score.

11. A system for credit risk prediction based on an Long Short-Term Memory (LSTM) model, comprising:
one or more processors; and
one or more computer-readable memories coupled to the one or more processors and having instructions stored thereon that are executable by the one or more processors to perform a method comprising:
obtaining behavior data of a target account in a period, wherein the period comprises a plurality of time intervals;
generating, based on the behavior data of the target account, a sequence of behavior vectors, each behavior vector corresponding to one of the time intervals;
inputting the generated sequence of behavior vectors into an LSTM encoder in an LSTM model to obtain hidden state vectors each corresponding to one of the time intervals, wherein the LSTM model comprises the LSTM encoder and an LSTM decoder; and
obtaining a risk score of the target account in a next time interval by inputting the hidden state vectors into the LSTM decoder, wherein the next time interval is next to the last time interval in the plurality of time intervals.

12. The system according to claim 11, wherein the method further comprises: obtaining a weight of each hidden state vector on the risk score from the LSTM decoder, wherein the weight of each hidden state vector indicates a contribution of the hidden state vector to the risk score.

13. The system according to claim 11, wherein the method further comprises:
obtaining behavior data of a plurality of sample accounts in the period comprising the plurality of time intervals;
generating, based on the behavior data of the plurality of sample accounts, a sample sequence of behavior vectors, each behavior vector in the sample sequence corresponding to one of the time intervals; and
training the LSTM model by using the generated sample sequence of behavior vectors as training samples.

14. The system according to claim 13, wherein obtaining behavior data of a plurality of sample accounts comprises: obtaining the behavior data based on a variety of user behaviors including one or more of credit performance behaviors, user consumption behaviors, and financial payment behaviors.

15. The system according to claim 13, wherein generating, based on the behavior data of the plurality of sample accounts, a sample sequence of behavior vectors comprises:
extracting one or more factors from the obtained behavior data of the sample accounts;
digitizing the one or more factors to obtain behavior vectors each corresponding to the behavior data in one of the time intervals; and
splicing the behavior vectors to obtain the sample sequence of the behavior vectors.

16. The system according to claim 15, wherein the factors comprise statuses of debit or credit orders and debit or credit repayment amounts corresponding to the credit performance behaviors, categories and quantities of user consumption corresponding to the user consumption behaviors, and financial payment types and financial income amounts corresponding to the financing payment behaviors.

17. The system according to claim 11, wherein inputting the generated sequence of behavior vectors into an LSTM encoder in an LSTM model to obtain hidden state vectors comprises:
inputting the generated sequence of behavior vectors into the LSTM encoder to obtain first hidden state vectors based on a forward propagation computation, each first hidden state vector corresponding to one of the time intervals;
inputting a reverse of the generated sequence of the behavior vectors into the LSTM encoder to obtain second hidden state vectors based on a back propagation computation, each second hidden state vector corresponding to one of the time intervals; and
for each time interval, splicing a first hidden state vector and a second hidden state vector both corresponding to the time interval to obtain the hidden state vector corresponding to the time interval.

18. The system according to claim 11, wherein inputting the hidden state vectors into the LSTM decoder to obtain a risk score of the target account in a next time interval comprises:
inputting the hidden state vectors into the LSTM decoder to obtain an output vector of the target account in the next time interval; and
digitizing the output vector to obtain the risk score of the target account in the next time interval.

19. The system according to claim 18, wherein the output vector is a multi-dimensional vector; and
digitizing the output vector comprises any one of the following:
extracting a value of a sub-vector in the output vector as a risk score, wherein the value is between 0 and 1;
in response to that the output vector comprises a plurality of sub-vectors whose values are between 0 and 1, calculating an average of the values of the plurality of sub-vectors as the risk score; and
in response to that the output vector comprises a plurality of sub-vectors whose values are between 0 and 1, extracting the maximal value or the minimal value of the values of the plurality of sub-vectors as the risk score.

20. A non-transitory computer-readable storage medium configured with instructions executable by one or more processors to cause the one or more processors to perform operations comprising:
obtaining behavior data of a target account in a period, wherein the period comprises a plurality of time intervals;
generating, based on the behavior data of the target account, a sequence of behavior vectors, each behavior vector corresponding to one of the time intervals;
inputting the generated sequence of behavior vectors into an LSTM encoder in an LSTM model to obtain hidden state vectors each corresponding to one of the time intervals, wherein the LSTM model comprises the LSTM encoder and an LSTM decoder; and
obtaining a risk score of the target account in a next time interval by inputting the hidden state vectors into the LSTM decoder, wherein the next time interval is next to the last time interval in the plurality of time intervals.
